(19) United States
(12) Patent Application Publication
(10) Pub. No.: US 2021/0312549 A1
(43) Pub. Date: Oct. 7, 2021

(54) Systems and Methods for Universal Custom Pairs Trading

(71) Applicant: Top Clan LLC, Hanover, MA (US)

(72) Inventor: Alexander Riadtchikov, New York, NY (US)

(73) Assignee: Top Clan LLC, Hanover, MA (US)

(21) Appl. No.: 17/220,020

(22) Filed: Apr. 1, 2021

Related U.S. Application Data
(60) Provisional application No. 63/003,351, filed on Apr. 1, 2020.

(51) Int. Cl. G06Q 40/04; G06Q 30/08; G06Q 20/06; G06Q 20/40

(52) U.S. Cl. CPC G06Q 40/04; G06Q 30/08; G06Q 2220/00; G06Q 20/4037; G06Q 20/0655

(57) ABSTRACT

Various embodiments are disclosed herein for allowing a user to generate and trade universal custom trading pairs. The embodiments may be further adapted to allow users to view real-time information for the universal custom trading pairs, which are updated as orders are placed, executed, and cancelled.

### CROSS-REFERENCE TO RELATED APPLICATIONS

The present application claims the benefit of U.S. Provisional Patent Application 63/003,351, titled “Systems and Methods for Universal Custom Pairs Trading,” filed Apr. 1, 2020, which is incorporated by reference herein in its entirety.

### BACKGROUND

This specification relates generally to systems and methods for providing a trading platform allowing for customized trading pairs. An electronic trading platform, also known as an online trading platform, is a computer software program that can be used to place orders for financial products over a network either with a financial intermediary or directly between the participants or members of the trading platform. Because the nature of trading is fast-paced, and thousands of trades can happen within a second of time, users need to be able to view pertinent information in real time in order to execute trades. Existing trading platforms generally support real-time trading features, including market analysis, market depth charts, live order books, etc.

However, such features are only available for listed assets and trading pairs that are commonly traded. Therefore, if a trader wants to exchange an asset which is not a listed trading pair including a major currency (e.g., the U.S. dollar), then there are no market trading tools or features available, except in a cross-currency exchange. However, even in the cross-currency exchange, the trader would need to first convert the one asset to an intermediary asset (e.g., the U.S. dollar), and then convert the intermediary asset into the target asset or another intermediary asset (which eventually is converted to the target asset). Such multi-leg trades carry greater risk than single-leg trades. During the time that it takes to execute these separate trades, the prices or volumes for one or more of the trades may have already moved significantly such that the trader is no longer able to execute one or more of the desired trades.

Furthermore, while the trader can create a synthetic instrument for the custom trading pair, it would be difficult to keep track of the movement of the separate trading pairs that make up the custom trading pair. Accordingly, there remains a need for a universal custom pairs trading platform to assist in the automatic execution of any trading pair which includes one or more common intermediary assets. It would be further beneficial if the platform supported real-time trading features, such as live order books, for the universal custom pairs trades.

### SUMMARY

In accordance with the foregoing objectives and others, exemplary methods and systems are disclosed herein to facilitate the creation, purchasing, selling, validation, registration, and other transactions relating to universal custom trading pairs of digital financial assets. The disclosed systems and methods may allow users to view real-time information for the universal custom trading pairs alongside the separate trading pairs constituting the custom trading pairs via a trading page including order books, charts, tables, etc. Such systems may be adapted to automatically update, store, and display information for trades as they are placed, executed, cancelled, etc.

In one embodiment, a method for generating a custom trading pair, displaying custom trading pair information, validating and executing the custom trading pair, transmitting and storing the executed order information, and updating the custom trading pair information is provided. The method may include displaying a form for generating a custom trading pair. The form may include one or more base assets and one or more quote assets. The method may further include receiving, from a user, a selected base asset and a selected quote asset. The method may include generating a custom trading pair. The custom trading pair may include a first trade and a second trade. The first trade may include selling the selected quote asset for an intermediary asset. The second trade may include selling the intermediary asset for the selected base asset. The intermediary asset may have a listed trading pair with the selected quote asset and also a listed trading pair with the selected base asset. The method may also include receiving a custom trading pair order associated with custom trading pair order information from the user. The custom trading pair information may include a requested volume of the base asset and a requested price per share of the base asset. The method may include generating a first trade order for the first trade and generating a second trade order for the second trade. The method may include determining that a first matching order for the first trade exists. The method may also include executing the first trade. The method may include determining that a second matching order for the second trade exists. The method may also include executing the second trade. The method may further include storing executed custom trading pair order information, including the amount of the selected base asset purchased and the amount of the selected quote asset sold, in a database.

In another embodiment, a system is provided that includes one or more computers and one or more storage devices storing instructions that when executed by the one or more computers cause the one or more computers to perform operations for generating a custom trading pair, displaying custom trading pair information, validating and executing the custom trading pair, transmitting and storing the executed order information, and updating the custom trading pair information. The operations performed may include displaying a form for generating a custom trading pair. The form may include one or more base assets and one or more quote assets. The operations performed may further include receiving, from a user, a selected base asset and a selected quote asset. The operations performed may include generating a custom trading pair. The custom trading pair may include a first trade and a second trade. The first trade may include selling the selected quote asset for an intermediary asset. The second trade may include selling the intermediary asset for the selected base asset. The intermediary asset may have a listed trading pair with the selected quote asset and also a listed trading pair with the selected base asset. The operations performed may also include receiving a custom trading pair order associated with custom trading pair order information from the user. The custom trading pair information may include a requested volume of the base asset and a requested price per share of the base asset. The operations performed may include generating a first trade order for the first trade and generating a second trade order for the second trade. The operations performed may include determining that a first matching order for the first trade exists. The operations performed may also include executing the first trade. The operations performed may include determining that a second matching order for the second trade exists. The operations performed may also include executing the second trade. The operations performed may further include storing executed custom trading pair order information, including the amount of the selected base asset purchased and the amount of the selected quote asset sold, in a database.

### BRIEF DESCRIPTION OF THE DRAWINGS

FIG. 1 shows an exemplary method 100 for generating information for a custom trading pair in real time, validating and executing a selected custom pair order, transmitting the executed custom trading pair order information, and updating the custom trading pair information.

FIG. 2 shows an exemplary user interface screen 200 of a custom trading pairs generator.

FIG. 3 shows an exemplary user interface screen 300 of a live market depth chart for a custom trading pair.

FIG. 4 shows an exemplary user interface screen 400 displaying a live order book for a custom trading pair.

FIG. 5 shows an exemplary user interface screen 500 displaying a market order form for a custom trading pair.

FIG. 6 shows an exemplary user interface screen 600 showing order results for a custom trading pair.

FIG. 7 shows a block diagram of an exemplary custom trading pair system 700 according to an embodiment.

FIG. 8 shows a block diagram illustrating a computing machine and modules 800 in accordance with one or more embodiments presented herein.

### DETAILED DESCRIPTION

Various systems and methods are provided herein that facilitate the creation, purchasing, selling, validation, registration, and other transactions relating to custom trading pairs of digital financial assets created by a user. The described embodiments may allow users to generate universal custom trading pairs, view custom trading pair information updated in real-time, and execute custom trading pair orders.

In certain embodiments, custom trading pair information may be received, determined and/or stored in a structured format. This allows for such information to be searched, filtered and/or employed to compare assets, buy orders, sell orders, separate trading pairs, etc. Accordingly, the embodiments may be adapted to display custom trading pair information that is customizable for each user.

It will be appreciated that the term “custom trading pair” refers to a trading pair that is not a major currency pair or a standard listed trading pair. It will further be appreciated that “universal” refers to the fact that the custom trading pair may involve any base asset and quote asset, as long as there is an intermediary asset that has a trading pair in common with both the base and quote asset.

It will be appreciated that a broad range of digital assets may be bought or sold throughout the trading platform. For convenience, such products and services are collectively referred to herein as “assets.” Moreover, institutional and individual traders are collectively referred to herein as “users” for convenience.

The embodiments may be utilized by a number of different types of users, such as but not limited to company/administrative users and traders. The company/administrative users may maintain content and oversee the operation of the trading system and as such, possess administrative privileges. Traders may utilize the platform to search for and generate custom trading pairs, view custom trading pair information, and execute trades.

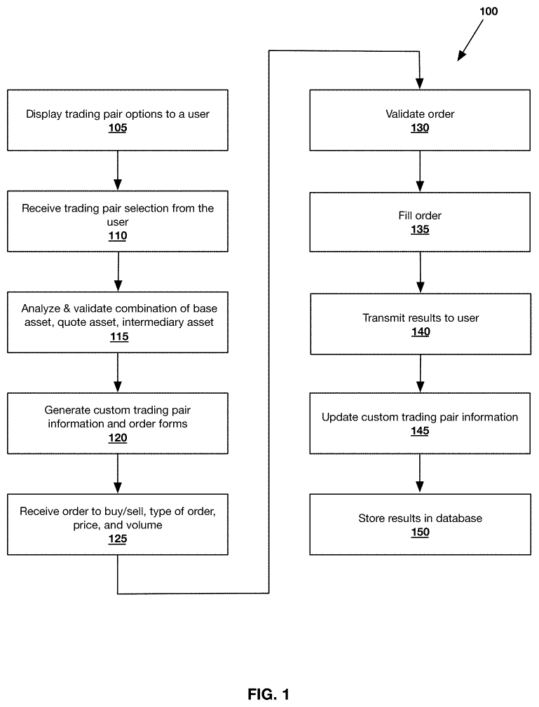

Referring to FIG. 1, an exemplary method 100 for executing a custom trading pair order is illustrated. As shown, the system may generate order forms for custom trading pairs and execute such custom trading pairs. The system may further provide real-time updates of custom trading pair information and display such updates through order books, market analysis charts, market depth charts, candlestick charts in real time as orders are placed, executed, and cancelled, instead of updating the information through the use of a static historical chart.

At step 105, the system displays a form for generating a custom trading pair, including available first assets and second assets for selection by a user. The form additionally includes an option to designate each of the first and second assets as either a base asset or a quote asset. Generally, the user may select a desired trading pair consisting of the intermediary asset, the base asset, and the quote asset. The assets may include any digital asset including: stocks, bonds, currencies, commodities, cryptocurrencies, utility tokens, platform tokens, security tokens (i.e. liquid contracts for fractions of any asset that already has value, including real estate, car, corporate stock, etc.), natural asset tokens, cryptocollectibles, crypto-fiat currencies, non-fungible tokens, etc.

In certain embodiments, the system may further allow a user to select an intermediary asset. Generally, intermediary assets must have trading pairs with both the base asset and the quote asset. In certain embodiments where the system allows the user to select an intermediary asset, the system may first receive a selection of one or more intermediary assets. Upon receiving a selection of an intermediary asset by the user, the system may update available options for the base and quote assets to show only those assets with which the selected intermediary asset has listed trading pairs.

In other embodiments, the system may first receive a selection of a base asset and may update the available options for the quote assets and intermediary assets. In yet other embodiments, the system may first receive a selection of a quote asset and may update the available options for the base assets and intermediary assets. In yet other embodiments, the system may only receive a selection of a base asset and a quote asset, and will determine the suitable intermediary asset.

At step 110, the system receives a selected base asset and a selected quote asset from the user. The custom trading pair selection may further include, or otherwise be associated with custom trading pair information relating to the trading pair (e.g., type or category of the intermediary, base, and quote assets) and user information relating to the user. Exemplary user information may include, but is not limited to: a name, username, password, location, phone, email address, age, gender, and/or payment information. User information may further include user activity information relating to one or more orders (i.e., the user's order history) and one or more trading pair selections. Each user of the trading system (and any/all corresponding user information) may be associated with a user profile that is stored in the database. And it will be appreciated that the system may receive user information from the one or more users and/or may automatically determine such information.

If, for example, the user chooses Asset 1 (herein referred to as “A”) as the base asset and Asset 2 (herein referred to as “B”) as the quote asset, then the user will view the custom trading pair as A/B. For example, if the cross-rate is such that one would need to buy 2 B's for 1 A, then the rate would be shown as follows: 2 (2÷1) A/B. If, on the other hand, the quote asset selection is chosen for A and the base asset selection is selected for B, then the user will view the exchange rate as: 0.5 (1÷2) B/A.

At step 115, the system analyzes and validates the combination of the selected base asset the selected quote asset. The system may validate the combination by ensuring that the selected quote asset and intermediary asset are listed trading pairs (the “first original trading pair”), and that the selected base asset and intermediary asset are listed trading pairs (the “second original trading pair”), and that the trading pairs still have a volume of greater than 0. It will be appreciated that the custom trading pair is the combination of the two separate trading pairs (the first original trading pair and the second original trading pair). The system may, upon validation, transform the custom trading pair into the first original trading pair and second original trading pairs. For example, where A is the base asset, B is the quote asset and C is the intermediary asset, the custom trading pair would be A/B, and the separate trading pairs would be in the form A/C and B/C. It will be appreciated that in certain embodiments, multiple intermediary assets may be involved in order to trade a quote asset for a base asset. For example, a user may wish to place a trade where A is the base asset, D is the quote asset, and no one intermediary asset exists for the A/D trading pair. However, there may be A/B, B/C, and C/D trading pairs, in which B and C are intermediary assets for the A/D trading pair. In such embodiments, the system may allow the user to select more than one intermediary asset, or may automatically determine that more than one intermediary asset is required to execute the trade upon receiving the selected base and quote asset from the user.

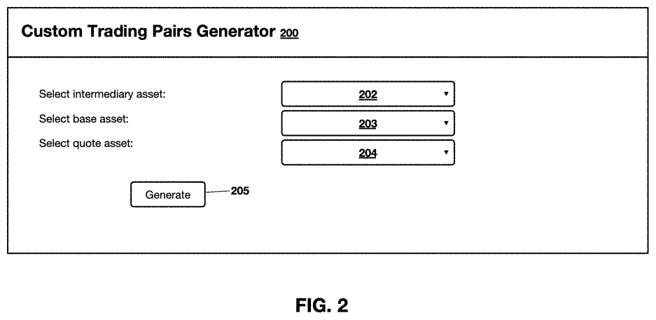

At step 120, the system generates and displays information for the custom trading pair via a custom pair trading page. The trading page may display both the custom trading pair information and information for the first original trading pair and the second original trading pair. All displayed information on the trading page is updated in real time as orders are placed and filled. The trading page may display the following custom trading pair information including but not limited to: the custom trading pair name (e.g., “A/B”), a custom trading pair market depth chart (discussed in detail below with respect to FIG. 2B), a custom trading pair order book (discussed in detail below with respect to FIG. 2C), a custom trading pair virtual candlestick chart, a custom trading pair buy (bid) and sell (ask) order form (discussed in detail with respect to FIG. 2D), order history of the custom trading pair, trade history of the custom trading pair, last price of the custom trading pair, market price change of the custom trading pair in the past 24 hours, highest price of the custom trading pair in the past 24 hours, lowest price of the custom trading pair in the past 24 hours, total volume of the custom trading pair traded in the past 24 hours, bid prices for the custom trading pair, bid volumes for the custom trading pair, ask prices for the custom trading pair, and ask volumes for the custom trading pair.

The trading page may also include first trading pair information including but not limited to: the first original trading pair name (e.g., “B/C”), a first original trading pair market depth chart, a first original trading pair order book, a first original trading pair virtual candlestick chart, order history of the first original trading pair, trade history for the first original trading pair, last price of the first original trading pair, market price change of the first original trading pair in the past 24 hours, highest price of the first original trading pair in the past 24 hours, lowest price of the first original trading pair in the past 24 hours, total volume of the first original trading pair traded in the past 24 hours, bid prices for the first original trading pair, bid volumes for the first original trading pair, ask prices for the first original trading pair, and ask volumes for the first original trading pair.

The trading page may also include second original trading pair information including but not limited to: the second original trading pair name (e.g., “A/C”), a second original trading pair market depth chart, a second original trading pair order book, a second original trading pair virtual candlestick chart, order history of the second original trading pair, trade history of the second original trading pair, last price of the second original trading pair, market price change of the second original trading pair in the past 24 hours, highest price of the second original trading pair in the past 24 hours, lowest price of the second original trading pair in the past 24 hours, total volume of the second original trading pair traded in the past 24 hours, bid prices for the second original trading pair, bid volumes for the second original trading pair, ask prices for the second original trading pair, and ask volumes for the second original trading pair. The trading page may also include an icon indicating that the current user is logged in.

Order history information may include order history for all open orders, including but not limited to: total number of orders, time and date of the order placement, trigger conditions, if other than a market order (e.g., limit order, stop order, stop-limit order, threshold value set for a limit/stop/limit-stop order), side of the order (e.g., bid or ask), price, amount, volume filled, total, trigger conditions (e.g., the threshold value set for a limit/stop order), whether the trading pair is a custom trading pair, and an option to cancel one or more of the orders. Order history information may also include order history for closed orders, which may be substantially similar to the open and/or cancelled order information and may additionally include duration of the order and the date and time that the order was settled.

It will be appreciated that in certain embodiments, the custom trading pair information, first original trading pair information, and second original trading pair information may be additionally or alternatively viewed via, for example: bar charts, equivolume stock charts, kagi charts, market profile stock charts, point and figure charts, range bar charts, renko charts, three-line break charts, tick charts, volume at price (VAP) stock charts, etc.

In other embodiments, the trading page may include information for only one of the pairs (e.g., the custom trading pair) and a drop-down list allowing the user to select a pair (e.g., the first original trading pair or the second original trading pair) in order to view the trading page for that pair.

In order to generate the custom trading pairs information, the system may first calculate such information via the generation of the first original trading pair and the second original trading pair. The first original trading pair includes at least one trade, where the selected quote asset is sold in exchange for the intermediary asset. The second original trading pair includes at least one trade, where the intermediary asset is sold in exchange for the base asset. In one example, for the A/B trading pair discussed above, the separate trading pairs may be A/C and B/C. The system may assign an inversion number of 0 for the A/C and B/C trading pairs format for A/B, and thus no inversion is needed. However, if the separate trading pairs are C/A and B/C, then the custom trading pair will be assigned an inversion number of 1, indicating that the C/A pair needs to be inverted. In the case where the separate trading pairs are A/C and C/B, the system will assign an inversion number 2, indicating that the C/B trading pair needs to be inverted. Finally, where the separate trading pairs are C/A and C/B, the system will assign an inversion number 3, indicating that both the separate trading pairs C/A and the C/B need to be inverted to the A/C and B/C format. Such assigned inversion numbers are used to calculate and place orders in the order books for the separate trading pairs, as well as to generate information on the custom trading pair (here, A/B) on the trading page.

The trading page may also display settings information allowing users to customize their settings. For example, users may be able to customize desired language to view the trading page, night mode on/off, notifications on/off, types of notifications (e.g., audio, visual, haptic, etc.), conditions for receiving notifications (e.g., the market price has reached a threshold value, a volume has reached a threshold value, an order has been filled, there is not enough intermediary asset to complete the transaction etc.), background and text colors, etc. Threshold values may be set automatically by the system and/or manually by the user. The user may also customize the type and number of charts to view on one page. For example, the user may choose to view the order forms, the live order books, and the market depth charts on one trading page, and may delete one of the charts and add other charts. The user may also resize such charts.

As another example, the user may choose to only view the custom trading pair information on the trading page, rather than view first original trading pair information and second original trading pair information. While choosing to view the custom trading pair information only may be optimal to achieve a simplified view of the market, the user may also find it beneficial to be able to view the liquidity or volume in one or more of the underlying separate trading pairs. The user may also filter and/or sort any of the custom trading pairs information displayed on the trading page by selecting a category to sort or filter by (e.g., by date, by type of order, price, etc.)

At step 125, the system receives, from the user, one or more custom trading pair orders and associated order information, including the type of order (e.g., limit, stop, or market), the side of the order (e.g., buy or sell), the volume of the order, and the price per share. For limit orders, the system would additionally receive a price indicating the limit (or trigger condition) for either buying and/or selling an asset. Specifically, a buy limit order can only be executed at the limit price or lower, while a sell limit order can only be executed at limit price or higher.

At step 130, the system validates the order by analyzing the original inversion number of the custom trading pair and original trading pair order books to ensure that the order is valid, and that the trade is still executable upon updating of the order books occurring between the time the order form was submitted and the time that the order is placed. For example, if an order is placed between custom order books updates, and one of the original trading pairs has traded off to 0 volume at the price desired by the user during the update, then the system may return an error message (e.g., “No trading volume in original order books. Please try again after the order book is updated”) instead of executing the order. If, in another example, a bid market order was submitted between custom order books recalculations and the ask order depth has become thin, pushing the price up such that no volume is available anymore at the original price at which the user submitted the order, the system may, instead of executing the order, return an error message (e.g., “No original prices matching your order. Please try again after the order book is updated.”)

Any number of factors may cause the market price to change from the time that a user places an order to the time the system executes it, including: volatility, momentum, depth of market, etc. For example, if the frequency of the trade is high and depth of market is high, then the likelihood of executing the order will be high. If the frequency of the trade is low and the depth of market is low, then the likelihood of executing the order will be low. Furthermore, if a user wants to trade at a very large volume, the likelihood of executing the order will be lower than if the user wants to trade a very small volume.

The system may further validate the order by: confirming the details of the order (e.g., trade date, value date, price, volume), verifying user information (e.g., requiring proof of identity via social media links, government-issued IDs, etc.) of the user placing the order, and registering the order. Further validation may be required for certain orders, including: trades that are deemed to be large (e.g., above a minimum threshold set by the system), orders in a specific security/market (e.g., a new market or a stock that trades infrequently), orders with a specific counterparty (e.g., a new broker or bank), orders with a value date in the past, orders with prices outside of a specified range (e.g., 5% above or below the current market price for the stock), etc. The system may block an order that fails the validation process, or in certain cases (e.g., large orders), the system may ask the user to confirm that he wants to submit the order.

Upon validating the order, the system may then generate the respective trade orders for the first original trading pair and the second original trading pairs.

At step 135, the system executes the custom trading pair order. With custom trading pairs, this will generally involve more than one trade—first, selling the selected quote asset for the intermediary asset, then selling the intermediary asset for the selected base asset. However, in other embodiments, this may only involve one trade. Generally, before executing the order, the system will need to determine that a matching order exists for at least a first trading pair order, or both the first trading pair order and the second trading pair order. For example, for the AB order discussed above, the system will execute the custom trading pair order by analyzing the A/C and B/C order books to find the optimal combination of matching buy/sell and sell/buy orders to fill the order volume at the optimal price for the A/C and B/C pairs, and place C/A and CB orders. For a market order, the system may fill the order at any time as long as the volume available to buy/sell is equal to or greater than the volume to sell/buy specified in the order. A market order may be split across multiple participants on the other side of the transaction, resulting in different prices for some of the shares.

For stop orders, limit orders, and stop-limit orders, the system only executes the order upon the trigger condition being met. For example, for a buy limit order, the system may first match the lowest sell order at or below the limit specified by the user and execute the trade. If the lowest sell order only partially fills the order, the system will execute the trade, analyze the order book for the next best sell order at or below the limit specified and execute that trade, and repeat the process until the ordered volume is fully filled. If an order book is unavailable, the system may return an error message (e.g., “Order book empty”).

Orders that require more than one trade may be filled in a “subsequent” or “virtually simultaneous” manner. For “subsequent” orders, there is no time limit for filling the order; orders are filled as matching orders arise. Therefore, one order may be filled first, then the next order may be filled at a later time when there's a matching order. “Subsequent” orders generally involve some delay. However, they do not involve any credits or require the user's balance (of the intermediary asset) to be involved in trades.

For example, if a user has submitted a limit order to buy 200 Etherium (“ETH) at 0.02 Bitcoin (“BTC”), and the user was able to buy 100 ETH at an ETH/USD rate of 0.02, but the only ask orders for BTC/USD are at a price of 0.2 and above, then the order will be partially filled as the first order would be executed, but the second order would be empty until the order can be filled by a matching ask order of 100 BTC/USD at a price of 0.02 or below. If for example, an ask order of 0.01 BTC/USD and a volume 50 then comes in, the system may fill the order of 50 BTC, and should seek to fill the remaining volume (50 BTC) at 0.03 BTC/USD or lower. If no matching orders at the desired price or below are available, then the order will remain open and partially filled until a matching order arises.

“Virtually simultaneous” orders are generally filled at a faster rate and are more precise than “subsequent” orders due to the fact that orders may be filled as soon as matching orders become available, regardless of whether the user has sufficient balance of the intermediary asset to carry out the trade. Instead, if the user's balance of the intermediary asset is insufficient, the system may act as an escrow to provide instant credit for the intermediary asset to execute transactions. For example, consider that an ask order of A/B with intermediary asset C has been placed. If the A/C ask order has been executed and there currently exists a matching C/B bid for the remaining C/B ask, but there is no or not enough balance of intermediary asset C on the user's account to execute the bid order, the system can provide the credit for intermediary asset C instantaneously.

In the described embodiments, the balance of the intermediary asset before and after transactions may be unchanged (e.g., the system only uses its own intermediary assets, not any of the user's). The system may set a limit for the maximum amount of intermediary assets it can provide a user in credit, and this may be determined according to the user's account level and/or on a case-by-case basis. For example, in embodiments where the system includes both a free version and a premium version (requiring payment by users) of the trading platform, the system may have a higher limit for premium users, while basic users (i.e. users who access the platform for free) may have a lower limit. Other factors may influence the maximum limits set for users, including: number of personal verifications submitted, total volume of trading activity, status of the user (e.g., institution or an individual), length of use, etc. For example, an institutional user may have a higher maximum limit set than an individual. In another example, an individual who has a track record of trading large volumes may also have a higher maximum limit set than an individual who has a track record of trading small volumes.

Upon using its own balance of an intermediary asset for a trade, the system may send the user details including volume of the intermediary asset used, as well as an invoice for the user to pay the total costs of the intermediary asset used. It will be appreciated that in such embodiments, the system may require the user to pay the invoice in full before executing further trades on behalf of the user.

In yet other embodiments, the system may “freeze” an order to secure a combination of orders at a certain price(s) to allow simultaneous filling of orders in both original order books. Such “freezing” may prevent the exchange or a user from having only one order(s) filled for the trading pair. In such a case, a service user account can be used as an intermediary for such a freeze, which executes a simultaneous trade for both original pairs and passes the assets to the user's account.

Upon filling the orders of the separate trading pairs, the system immediately processes the executed custom trading order information. If the system is unable to execute the orders, it will place orders for each of the separate trading pairs and update the system with order placement details accordingly.

At step 140, the system may notify the user of the executed custom trading order and transmit the executed custom trading order information to the user (discussed further below with respect to FIG. 2E). Generally, the executed custom trading order information transmitted to the user may include: date and time that the custom trading order was placed, date and time that the custom trading order was executed, original trading pairs orders and the volumes of assets sold and/or purchased, executed custom trading pairs orders and the volumes of assets sold and/or purchased, total prices of assets sold and/or purchased of the original trading pairs orders and custom trading pairs orders, total prices per shares of assets sold and/or purchased of original trading pairs orders and custom trading pairs orders, total volumes of assets sold and/or purchased of original trading pairs orders and custom trading pairs orders, any applicable trigger conditions, and service information (e.g., reference number, order ID, timestamp, inversion ID (for converting back to the standard trading pair)), broker fees, payment information, etc. Ideally, there would be no or negligible difference between the volumes, prices, and totals of both of the separate trading pairs orders combined compared with the volume, price, and total of the custom trading pairs order.

At step 145, the system may update the custom trading pair information with the executed custom trading pair order information in the system, including in all relevant order books, market depth charts, candlestick charts, etc.

At step 150, the system may store the order execution information in a database.

Referring to FIG. 2, an exemplary user interface screen 200 of a custom trading pairs generator is illustrated. As shown, the custom trading pairs generator allows the user to first select an intermediary asset. In the described embodiments, the selection may be in the form of a drop-down list 202 of available intermediary assets. Upon selection of the intermediary asset, the user may then select a base asset via the drop-down list 203. In such embodiments, the selection of the base asset is limited to assets which have pairs with the intermediary asset as well as available trading volume. While in the preferred embodiment, the list is a drop-down list, it will be appreciated that other selection options are available, including auto-fill form, textual form, etc.

Upon selection of the first asset, the user may then select a quote asset via drop-down list 204. In such embodiments, the available selections of the quote asset are limited to assets which have pairs with the first asset. The user may then select a link 205 to generate the trading page for the selected custom pair.

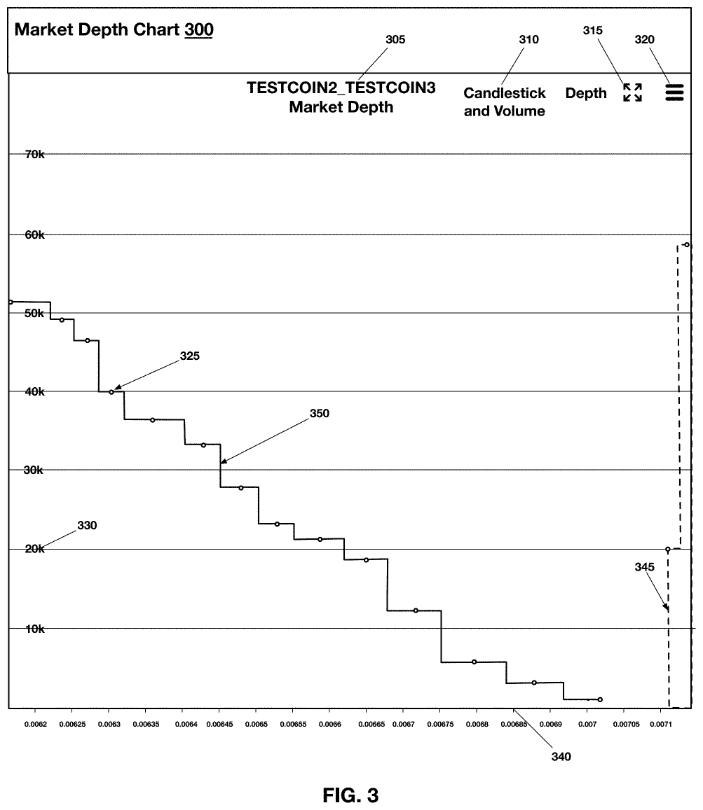

Referring to FIG. 3, an exemplary user interface screen 300 of a live market depth chart for a custom trading pair TESTCOIN2/TESTCOIN3 is illustrated. Generally, the market depth chart may be displayed on the trading page, and may generally show a visual representation of buy and sell orders for the custom trading pair. As shown, the market depth chart includes a title 305 indicating that it is a market depth chart for the trading pair “TESTCOIN2_TESTCOIN3,” a link 310 to switch to another chart (e.g., a candlestick and volume chart, a historical data chart, etc.), a link 315 to expand the chart, and a link 320 to view and/or change settings/account information. Such settings may include: chart settings (e.g., background settings, text settings, size settings, etc.), notification settings, user account information, etc.

The x-axis values 340 generally represent the price of one share of the base asset in terms of the quote asset (e.g., TESTCOIN3). Generally, the x-axis will range from 0 to the highest current ask price (e.g., 0.0075) for the trading pair. The x-axis may include predetermined intervals set either manually or automatically. In the embodiment shown, the interval is set at 0.00005, but any interval may be set.

The y-axis values 330 generally represent the volume depicted in terms of the base asset (e.g., TESTCOIN2). Generally, the volume will range from 0 to the highest total volume of the base asset for the trading pair. In the embodiment shown, the volume may range from 0 to 70,000. Generally, the y-axis may include predetermined intervals set by either the system or the user. In the embodiment shown, the interval is set at 10,000, but any interval may be set.

The chart may continually update in real-time upon the placement and execution of orders, as the system will dynamically recalculate volumes and prices based on each placed, executed, and cancelled order. For example, if the current volume of ask orders at a price of 0.00712 is around 23,000, and a user places a buy order at a price of 0.00712 at 23,500, then once the orders are matched and filled, the ask volume at price 0.00712 will become 0. This will be immediately indicated on the market depth chart, as 0 ask volume shown under the price 0.00712.

The buy and sell orders may be represented by two distinct line graphs. For example, in the embodiment shown, the solid line graph 350 on may represent the buy orders, while the dotted line graph 345 may represent the sell orders. In other embodiments, It will be appreciated that the distinct line graphs may be represented in a number of different ways (e.g., different line colors, different fill colors, etc.) The system may indicate a mid-range price at a given volume. For example, the point 325 on the buy orders graph indicates that there is a total buy volume of 40,000 COIN2 at a price of 0.0063 COIN3 and above.

In certain embodiments, the user may hover over a point on the buy or sell order graphs, and the system may display information at the point. For example, if a user hovers over a point on the ask order graph, the system may show information including: the price at the point, a total amount of the quote asset that can be purchased at the point, a total cost to purchase the total amount of the quote asset in terms of the base asset, etc.

As discussed above, the interface screen may also include a link 310 allowing users to view other live charts, including candlestick and volume charts, historical data, and depth charts. Generally, candlestick charts show a graphical representation of trades in the form of a “candle”, including: open and close executed trade prices, and high and low executed trade prices. While the color of each candle depends on the settings (which may be customizable) generally, green candles (e.g., bullish candles) reflect that the price closed higher than where it opened, and red candles (e.g., bearish candles) reflect that the prices closed lower than where it opened.

Another chart (not shown) may include a volume chart, which generally shows the number of shares traded within a predetermined period of time (e.g., 1 minute). Generally, volume bars may be colored, and a red volume bar may mean that price declined during that period and the market considers the volume during that period as selling volume (estimated). A green volume bar generally indicates that the price rose during that period and it is considered by the market as buying volume.

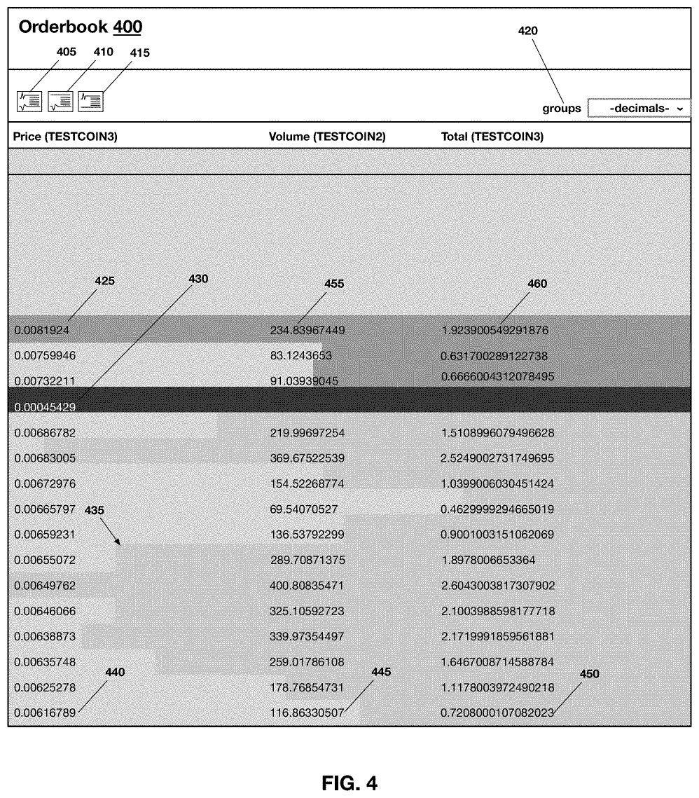

Referring to FIG. 4, an exemplary user interface screen 400 displaying a live order book for a custom trading pair TESTCOIN2/TESTCOIN3 is illustrated. Generally, a live order book displays all of the open buy and sell orders for the trading pair. The order book may be arranged according to price-time priority, which gives priority to the first highest buy orders and the first lowest ask offers. Other variations may also be possible, including prize-size-time priority, in which larger orders have priority over smaller orders of the same price, even if they were ordered later in time. The user may filter the order book to view desired bids and/or asks (e.g., by way of bilateral filtering).

Although not shown, generally, bid prices (e.g., bid price 440), bid volumes (e.g., volume 445) and bid totals (e.g., volume 450) may be shown in a different color text or background (e.g., green) than the ask prices (e.g., ask price 425), ask volumes (e.g., ask volume 455), and ask totals (e.g., ask total 460). The bid-ask spread (e.g., bid-ask spread 430) may also be shown in a different color text (e.g., white) or background (e.g., black) than the bid and ask prices, volumes, and totals. The total volume that is requested at each price point may be shown visually as a bar (e.g., bar 435) that increases/decreases in real time as trades are executed. Any changes in the order book may also be highlighted in real time on the chart.

Generally, the system may display the custom pair order book with the custom trading pair. The system may additionally or alternatively display separate order books for each of the separate trading pairs constituting the custom trading pair.

Upon placing an order, the system immediately updates, adds, and/or removes certain orders in the order book. If a matching buy and sell order for a price trades down the volume at the price to 0, then the price level will have no more volume and will be removed from the order book. Generally, if the number of buy orders for a security increases, the price level of the security increases, and vice versa.

To generate and update the custom order book A/B, the system may first retrieve C/A and C/B order book information. The system may populate C/A buy and sell orders and combine the orders into an array in order to generate a C/A order book. The system may further populate C/B buy and sell orders and combine the orders into a second array in order to generate a C/B order book. It will be appreciated that if any of the order book pairs is not in the order C/A or C/B (e.g., A/C), then the system would first convert the pair to one where C is the base asset according to the following formulas:

Ask QUOTE=1/Bid BASE

Bid QUOTE=1/Ask BASE

Upon generating the order book, the system may update the order book upon any changes in C/A and/or C/B. The system may calculate A/B buy and sell cross-rates using the buy and sell rates of the C/A and C/B pairs. The system may further calculate the A/B buy and sell volumes and totals at a given A/B cross-rate. The system may also calculate average buy and sell prices. The system may include a link 405 allowing the user to view both buy and sell orders in the order book, a link 410 allowing the user to view only buy orders, and a link 415 allowing the user to view only sell orders. The system may further allow users to view the prices, volumes, and totals in decimal format, but may include a drop-down list 420 allowing users to view the prices in fractional format instead.

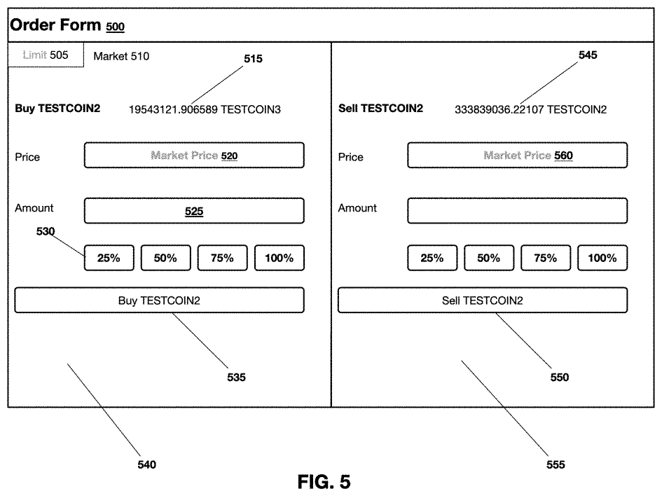

Referring to FIG. 5, an exemplary user interface screen 500 displaying a market order form for the trading pair TESTCOIN2/TESTCOIN3 is shown. Generally, as discussed above with respect to FIG. 1, the order form may be displayed on the trading page along with other charts and information. The system may generally support a number of different types of orders, including: limit orders, market orders, stop orders, and stop-limit orders. As such, the order form may include tabs representing each type of order form (e.g., a limit order tab 505, a market order tab 510, a stop order tab (not shown), etc.) available to a user. The system may allow the user to place both a buy and a sell order at the same time.

As shown, the market order form may include a buy order form 540 and a sell order form 555. The buy order form 540 may display the user's available balance 515 of the quote asset (e.g., 19543121.906589 of TESTCOIN3), which represents the maximum amount of quote asset that the user can sell in exchange for the base asset (e.g., TESTCOIN2). On the other hand, the sell order form 555 may display the user's available balance 545 of the base asset, which represents the maximum amount of the base asset that the user can sell.

The market order tab 510 may also include fields 520, 560 allowing the user to input a price at which to buy or sell the base asset. In the embodiment shown, for the market order form, the price may automatically be set as the current market price. For other order forms, such as the limit order and stop order forms (not shown), the price may be set either automatically or manually by the user. The form may include an amount field 525 allowing the user to input an amount of the base asset to purchase or sell.

The system may also allow the user to select a percentage of his balance of assets to either buy or sell, instead of manually calculating and inputting an amount. For example, the selection may include an option 530 to sell 25% of TESTCOIN3 in order to buy TESTCOIN2. While in the described embodiments, users may make a selection to sell the quote asset or buy the base asset at 25%, 50%, 75%, or 100% of their outstanding balances, in other embodiments the user may be able to specify a different, or custom proportion. Upon receiving a selection of a percent to sell/buy, the system may automatically populate the amount field with the selected share of the current balance.

Finally, the system may include links 535, 550 allowing the user to either buy or sell the base asset. Upon the user's selection, the system will immediately convert the custom trading pair back to its original trading pairs and place the orders in the C/A and CB order books.

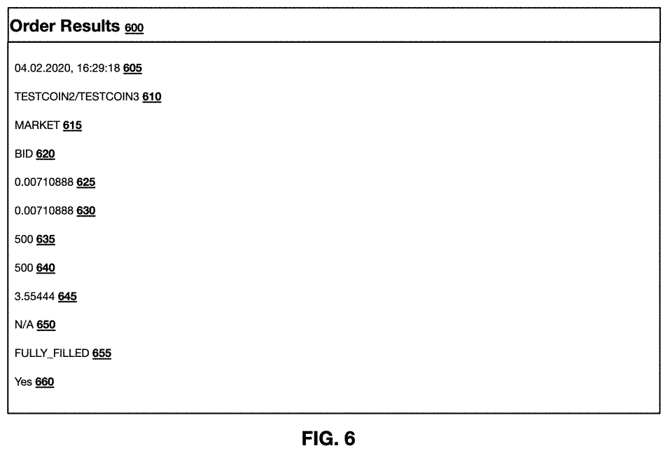

Referring to FIG. 6, an exemplary user interface screen 600 showing order results for a custom trading pair TESTCOIN2/TESTCOIN3 is displayed. As shown, the results may include: the date and the time at which the order was placed/settled 605; the name of the trading pair 610; whether the order was a limit, market, stop, or stop-limit order; whether the order was a bid or ask order 620; the prices 625, 630 of the original trading pair orders and the custom trading pair; the volumes 635, 640 of the assets traded pertaining to the original trading pairs and custom trading pair; the total price 645 of the custom trading pair; a trigger condition threshold price or volume (if applicable) 650 (e.g., N/A for market order forms); the status of the order 655 (e.g., “FULLY FILLED,” “OPEN,” “PARTIALLY FILLED,” etc.); and whether the order involved a custom trading pair or not 660. Although not shown, the order results may additionally include service information (e.g., reference number, order ID, timestamp, inversion ID, fees, etc.)

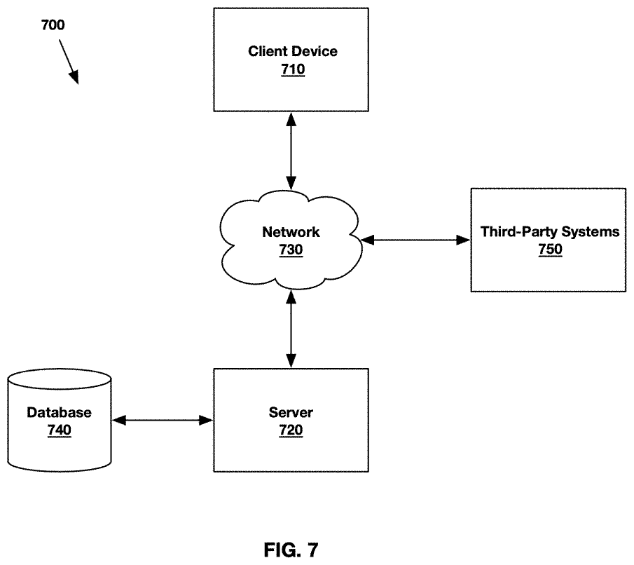

Referring to FIG. 7, a block diagram 700 of an exemplary trading system according to an embodiment is illustrated. As shown, the system comprises any number of users accessing a server 720 via a network 730. In certain embodiments, a user may access the server 720 via a client device 710 connected to the network 730.

Generally, a client device 710 may be any device capable of running a client application and/or of accessing the server 720 (e.g., via the client application or via a web browser). Exemplary client devices 710 may include general purpose desktop computers, laptop computers, smartphones, and/or tablets.

The relationship of client 710 and server 720 arises by virtue of computer programs running on the respective computers and having a client-server relationship to each other. Accordingly, each of the client devices 710 may have a client application comprising various modules, such as an order book generation and processing module, an asynchronous messaging module, an order processing and matching module, etc. running thereon, where the client application may be adapted to communicate with a server application running on a server 720, for example, over a network 730. Thus, the client application and server 720 may be remote from each other. Such a configuration may allow users of client applications to input information and/or interact with the server from any location.

As discussed above, a client application may be adapted to present various user interfaces to users. Such user interfaces may be based on information stored on the client device 710 and/or received from the server 720. Accordingly, the client application may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code).

In certain embodiments, the server 720 and/or the client device 710 may be adapted to receive, determine, record and/or transmit application information. The application information may be received from and/or transmitted to the client application. Moreover, any of such application information may be stored in and/or retrieved from one or more local or remote databases (e.g., database 740).

In one embodiment, the server 720 may be connected to one or more third-party systems 750 via the network 730. Third-party systems 750 may store information in one or more databases that may be accessed by the server. Exemplary third-party systems may include, but are not limited to: payment and billing systems, messaging systems, cloud-based storage and backup systems, financial systems and others. The server 720 may be capable of retrieving and/or storing information from third-party systems 750, with or without user interaction. Moreover, the server may be capable of transmitting stored information to third-party systems.

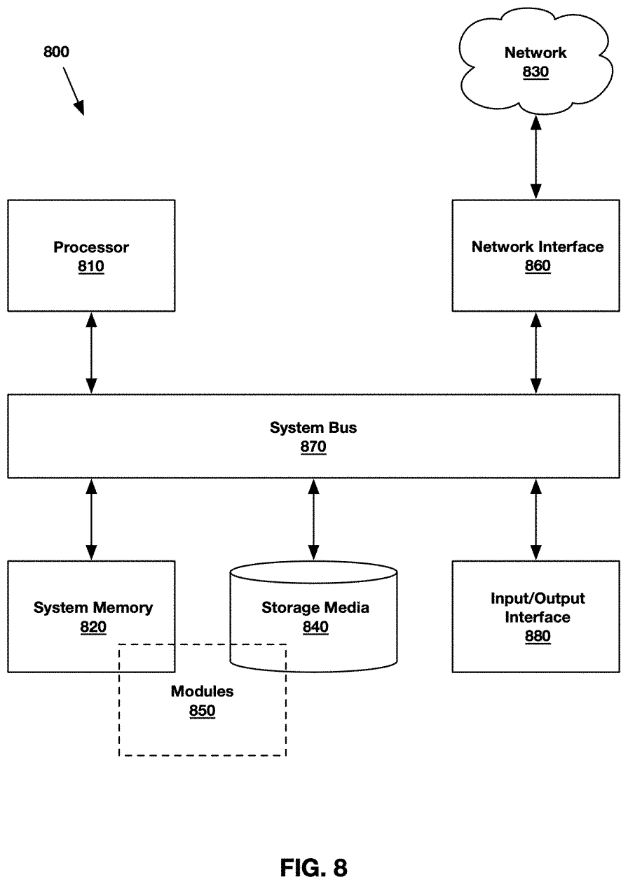

Referring to FIG. 8, a block diagram is provided illustrating a computing machine 800 and modules 850 in accordance with one or more embodiments presented herein. The computing machine 800 may correspond to any of the various computers, servers, mobile devices, embedded systems, or computing systems presented herein (e.g., the client device(s) 710, server(s) 720, and/or third-party system(s) 750 of FIG. 7). The modules 850 may comprise one or more hardware or software elements configured to facilitate the computing machine 800 in performing the various methods and processing functions presented herein.

The computing machine 800 may comprise all kinds of apparatuses, devices, and machines for processing data, including but not limited to, a programmable processor, a computer, and/or multiple processors or computers. As shown, an exemplary computing machine 800 may include various internal and/or attached components, such as a processor 810, system bus 870, system memory 820, storage media 840, input/output interface 880, and network interface 860 for communicating with a network 830.

The computing machine 800 may be implemented as a conventional computer system, an embedded controller, a laptop, a server, a mobile device, a smartphone, a kiosk, one more processors associated with a display, a customized machine, any other hardware platform and/or combinations thereof. Moreover, a computing machine may be embedded in another device, such as a smartphone, a tablet, a mobile audio or video player, a game console, or a portable storage device (e.g., a universal serial bus (“USB”) flash drive). In some embodiments, the computing machine 800 may be a distributed system configured to function using multiple computing machines interconnected via a data network or system bus 870.

The processor 810 may be configured to execute code or instructions to perform the operations and functionality described herein, manage request flow and address mappings, and to perform calculations and generate commands. The processor 810 may be configured to monitor and control the operation of the components in the computing machine 800. The processor 810 may be a general-purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 810 may be a single processing unit, multiple processing units, a single processing core, multiple processing cores, special purpose processing cores, coprocessors, or any combination thereof. In addition to hardware, exemplary apparatuses may comprise code that creates an execution environment for the computer program (e.g., code that constitutes one or more of: processor firmware, a protocol stack, a database management system, an operating system, and a combination thereof). According to certain embodiments, the processor 810 and/or other components of the computing machine 800 may be a virtualized computing machine executing within one or more other computing machines.

The system memory 820 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 820 also may include volatile memories, such as random-access memory (“RAM”), static random-access memory (“SRAM”), dynamic random-access memory (“DRAM”), and synchronous dynamic random-access memory (“SDRAM”). Other types of RAM also may be used to implement the system memory. The system memory 820 may be implemented using a single memory module or multiple memory modules. While the system memory is depicted as being part of the computing machine 800, one skilled in the art will recognize that the system memory may be separate from the computing machine without departing from the scope of the subject technology. It should also be appreciated that the system memory may include, or operate in conjunction with, a non-volatile storage device such as the storage media 840.

The storage media 840 may include a hard disk, a compact disc read only memory (“CD-ROM”), a digital versatile disc (“DVD”), a Blu-ray disc, a magnetic tape, a flash memory, other non-volatile memory device, a solid-state drive (“SSD”), any magnetic storage device, any optical storage device, any electrical storage device, any semiconductor storage device, any physical-based storage device, any other data storage device, or any combination or multiplicity thereof. The storage media 840 may store one or more operating systems, application programs and program modules such as module, data, or any other information. The storage media may be part of, or connected to, the computing machine 800. The storage media may also be part of one or more other computing machines that are in communication with the computing machine such as servers, database servers, cloud storage, network attached storage, and so forth.

The modules 850 may comprise one or more hardware or software elements configured to facilitate the computing machine 800 with performing the various methods and processing functions presented herein. The modules 850 may include one or more sequences of instructions stored as software or firmware in association with the system memory 820, the storage media 840, or both. The storage media 840 may therefore represent examples of machine or computer readable media on which instructions or code may be stored for execution by the processor. Machine or computer readable media may generally refer to any medium or media used to provide instructions to the processor. Such machine or computer readable media associated with the modules may comprise a computer software product. It should be appreciated that a computer software product comprising the modules may also be associated with one or more processes or methods for delivering the module to the computing machine via the network, any signal-bearing medium, or any other communication or delivery technology. The modules 850 may also comprise hardware circuits or information for configuring hardware circuits such as microcode or configuration information for an FPGA or other PLD.

The input/output (“I/O”) interface 880 may be configured to couple to one or more external devices, to receive data from the one or more external devices, and to send data to the one or more external devices. Such external devices along with the various internal devices may also be known as peripheral devices. The I/O interface 880 may include both electrical and physical connections for operably coupling the various peripheral devices to the computing machine 400 or the processor 410. The I/O interface 880 may be configured to communicate data, addresses, and control signals between the peripheral devices, the computing machine, or the processor. The I/O interface 880 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface may be configured to implement only one interface or bus technology. Alternatively, the I/O interface may be configured to implement multiple interfaces or bus technologies. The I/O interface may be configured as part of, all of, or to operate in conjunction with, the system bus 870. The I/O interface 880 may include one or more buffers for buffering transmissions between one or more external devices, internal devices, the computing machine 800, or the processor 810.

The I/O interface 880 may couple the computing machine 800 to various input devices including mice, touch-screens, scanners, biometric readers, electronic digitizers, sensors, receivers, touchpads, trackballs, cameras, microphones, keyboards, any other pointing devices, or any combinations thereof. When coupled to the computing device, such input devices may receive input from a user in any form, including acoustic, speech, visual, or tactile input.

The I/O interface 880 may couple the computing machine 800 to various output devices such that feedback may be provided to a user via any form of sensory feedback (e.g., visual feedback, auditory feedback, or tactile feedback). For example, a computing device can interact with a user by sending documents to and receiving documents from a device that is used by the user (e.g., by sending web pages to a web browser on a user's client device in response to requests received from the web browser). Exemplary output devices may include, but are not limited to, displays, speakers, printers, tactile feedback devices, automation control, actuators, transmitters, signal emitters, lights, and so forth. And exemplary displays include, but are not limited to, one or more of: projectors, cathode ray tube (“CRT”) monitors, liquid crystal displays (“LCD”), light-emitting diode (“LED”) monitors and/or organic light-emitting diode (“OLED”) monitors.

Embodiments of the subject matter described in this specification can be implemented in a computing machine 800 that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network.

Accordingly, the computing machine 800 may operate in a networked environment using logical connections through the network interface 860 to one or more other systems or computing machines across the network 830. The network 830 may include wide area networks (“WAN”), local area networks (“LAN”), intranets, the Internet, wireless access networks, wired networks, mobile networks, telephone networks, optical networks, or combinations thereof. The network 830 may be packet switched, circuit switched, of any topology, and may use any communication protocol. Communication links within the network 830 may involve various digital or an analog communication media such as fiber optic cables, free-space optics, waveguides, electrical conductors, wireless links, antennas, radio-frequency communications, and so forth.

The processor 810 may be connected to the other elements of the computing machine 800 or the various peripherals discussed herein through the system bus 870. It should be appreciated that the system bus 870 may be within the processor, outside the processor, or both. According to some embodiments, any of the processor 810, the other elements of the computing machine 800, or the various peripherals discussed herein may be integrated into a single device such as a system on chip (“SOC”), system on package (“SOP”), or ASIC device.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A computer-implemented method of executing an order for a custom trading pair, the method comprising:
displaying, by a computer, a form for generating a custom trading pair, wherein the form comprises one or more base assets and one or more quote assets;
receiving, by the computer, from a user, a selected base asset and a selected quote asset;
generating, by the computer, a custom trading pair comprising a first trade and a second trade, wherein:
the first trade comprises selling the selected quote asset for an intermediary asset, and
the second trade comprises selling the intermediary asset for the selected base asset, and
wherein the intermediary asset has a listed trading pair with the selected quote asset and a listed trading pair with the selected base asset;
receiving, by the computer, a custom trading pair order associated with custom trading pair order information from the user comprising:
a requested volume of the selected base asset, and
a requested price per share of selected the base asset;
generating, by the computer, a first trade order for the first trade;
generating, by the computer, a second trade order for the second trade;
determining, by the computer, that a first matching order for the first trade order exists;
executing, by the computer, the first trade;
determining, by the computer, that a second matching order for the second trade order exists;
executing, by the computer, the second trade; and
storing, by the computer, executed custom trading pair order information comprising the amount of the selected base asset purchased and the amount of the selected quote asset sold.

2. The computer-implemented method according to claim 1, wherein the executed custom trading pair information further comprises one or more trigger conditions consisting of a limit price and a stop price.

3. The computer-implemented method according to claim 1, wherein each of the base asset, the quote asset, and the intermediary asset comprises a digital asset.

4. The computer-implemented method according to claim 3, wherein the digital asset comprises one or more of the group consisting of: stocks, bonds, currencies, commodities, cryptocurrencies, utility tokens, platform tokens, security tokens, natural asset tokens, cryptocollectibles, crypto-fiat currencies, and non-fungible tokens.

5. The computer-implemented method according to claim 1, further comprising displaying, by the computer, custom trading pair information to the user.

6. The computer-implemented method according to claim 5, wherein the custom trading pair information comprises: name of the custom trading pair, a custom trading pair market depth chart, a custom trading pair order book, a custom trading pair virtual candlestick chart, order history of the custom trading pair, trade history of the custom trading pair, last price of the custom trading pair, market price change of the custom trading pair in the past 24 hours, highest price of the custom trading pair in the past 24 hours, lowest price of the custom trading pair in the past 24 hours, total volume of the custom trading pair traded in the past 24 hours, bid prices for the custom trading pair, bid volumes for the custom trading pair, ask prices for the custom trading pair, and ask volumes for the custom trading pair.

7. The computer-implemented method according to claim 1, wherein the executing of the first trade and the second trade occurs in a subsequent or a virtually simultaneous manner.

8. The computer-implemented method according to claim 7, wherein the executing of the first trade and the second trade in a subsequent manner occurs upon the determination that the user has a sufficient balance of the quote asset necessary to execute the first trade and a sufficient balance of the intermediary asset necessary to execute the second trade.

9. The computer-implemented method according to claim 7, wherein the executing of the first trade and the second trade in a virtually simultaneous manner occurs upon the determination that the user does not have a sufficient balance of the intermediary asset to execute the second trade.

10. The computer-implemented method according to claim 9, further comprising providing, by the computer, an instantaneous credit of a sufficient amount of the intermediary asset to execute the second trade.

11. The computer-implemented method according to claim 1, wherein the executed custom trading pair order information further comprises one or more of the group consisting of: price per share of the selected quote asset that was sold, price per share of the selected base asset that was bought, date of the placing of the custom trading pair order, time of the placing of the custom trading order, date of the executing of the custom trading pair order, time of the executing of the custom trading pair order, and service information.

12. The computer-implemented method according to claim 11, wherein the service information further comprises one or more of the group consisting of: an identification number of the custom trading pair order, an inversion number, a broker fee, and payment information.

13. The computer-implemented method according to claim 1, wherein the computer may further display the user's available balance of the selected quote asset.

14. The computer-implemented method according to claim 1, further comprising transmitting, by the computer, executed custom trading pair order information to the user upon the executing of the second trade.

15. The computer-implemented method according to claim 1, further comprising validating, by the computer, the selected base asset, the selected quote asset, and the intermediary asset.

16. The computer-implemented method according to claim 15, wherein the validating of the selected base asset, the selected quote asset, and the intermediary asset comprises confirming that the volume of each of the selected base asset, the selected quote asset, and the intermediary asset is greater than 0.

17. The computer-implemented method according to claim 1, wherein the selling of the quote asset for the intermediary asset further comprises more than one trade.

18. The computer-implemented method according to claim 1, wherein the selling of the intermediary asset for the base asset further comprises more than one trade.

19. The computer-implemented method according to claim 1, further comprising:
displaying, by the computer, one or more intermediary assets; and
receiving, by the computer, from the user, a selected intermediary asset.

20. A system comprising one or more computers and one or more storage devices storing instructions that when executed by the one or more computers cause the one or more computers to perform operations comprising:
displaying a form for generating a custom trading pair, wherein the form comprises one or more base assets and one or more quote assets;
receiving, from a user, a selected base asset and a selected quote asset;
generating a custom trading pair comprising a first trade and a second trade, wherein:
the first trade comprises selling the selected quote asset for an intermediary asset, and
the second trade comprises selling the intermediary asset for the selected base asset, and
wherein the intermediary asset has a listed trading pair with the selected quote asset and a listed trading pair with the selected base asset;
receiving a custom trading pair order associated with custom trading pair order information from the user comprising:
a requested volume of the selected base asset, and
a requested price per share of selected the base asset;
generating a first trade order for the first trade;
generating a second trade order for the second trade;
determining that a first matching order for the first trade order exists;
executing the first trade;
determining that a second matching order for the second trade order exists;
executing the second trade; and
storing executed custom trading pair order information comprising the amount of the selected base asset purchased and the amount of the selected quote asset sold.
